(19) United States
(12) Patent Application Publication
(10) Pub. No.: US 2004/0219925 A1
(43) Pub. Date: Nov. 4, 2004

(54) Image data transfer over a dispatch voice channel

(75) Inventors: Deepak Ahya, Plantation, FL (US); Adeel Mukhtar, Plantation, FL (US)

Correspondence Address: FLEIT, KAIN, GIBBONS, GUTMAN, BONGINI, & BIANCO P.L., 551 N.W. 77TH STREET, SUITE 111, BOCA RATON, FL, 33487, US

(73) Assignee: MOTOROLA, INC., Schaumburg, IL

(21) Appl. No.: 10/427,069

(22) Filed: Apr. 30, 2003

(51) Int. Cl. H04Q 7/20; H04B 7/00

(52) U.S. Cl. 455/450; 455/509; 455/517

(57) ABSTRACT

Systems and methods are provided for transmitting non-voice data over a dispatch voice channel of a wireless network. A request is received from a user of a first wireless device to transfer non-voice data, and a private call request is transmitted to the wireless network. The private call request includes information indicating image transfer over dispatch voice channel mode. A call grant message is received from the wireless network and indicates a first dispatch voice channel that has been allocated to the first wireless device. The non-voice data is transmitted from the first wireless device to the second wireless device via the first dispatch voice channel. Also provided are systems and methods for temporarily interrupting the transmission of non-voice data via a dispatch voice channel so as to transmit voice data via the dispatch voice channel.

### FIELD OF THE INVENTION

The present invention generally relates to the field of wireless communications, and more particularly relates to image data exchange between wireless devices.

### BACKGROUND OF THE INVENTION

With the advent of pagers and mobile phones the wireless service industry has grown into a multi-billion dollar industry. Recently, push-to-talk wireless devices have grown in popularity. Push-to-talk wireless devices allow two-way analog radio-like communication in which only one user can speak at a time and a user pushes a button to commence speaking. The recent integration of color displays and camera sensors to wireless devices has enabled a great number of new applications. However, in all 2.5 generation (2.5G) and 2.75 generation (2.75G) networks (interim classifications between second generation, 2G, and third generation, 3G, networks) voice and data channels are bifurcated and only one (either voice or data) channel can be used at one time. Thus, a user cannot transmit voice and data (such as image data) at the same time. Additionally, there is a significant time to access packet data and transfer multiple packets. This adds a delay when transmitting data over the data channel.

Current solutions to the problem of bifurcated networks involve attempts to go back and forth between using a packet data channel to transmit an image and a dispatch voice channel to transmit speech. This, however, poses user interface issues. Additionally, in order to transmit an image to another subscriber using a packet data channel requires the transmitting unit to know the IP address of the receiving unit. This can be accomplished by polling the Domain Name Server (DNS) in the network or via exchange of IP addresses over the dispatch channel. This, however, adds overhead time for acquiring the IP address for transmitting the image. Therefore, there is currently no solution for transmitting voice and data seamlessly from the end user's point of view.

Therefore a need exists to overcome the problems with the prior art as discussed above.

### SUMMARY OF THE INVENTION

Briefly, in accordance with the present invention, disclosed are systems and methods for transmitting non-voice data over a dispatch voice channel of a wireless network. In one embodiment, a request is received from a user of a first wireless device to transfer non-voice data, and a private call request is transmitted to the wireless network. The private call request includes information indicating image transfer over dispatch voice channel mode. A call grant message is received from the wireless network and indicates a first dispatch voice channel that has been allocated to the first wireless device. The non-voice data is transmitted from the first wireless device to the second wireless device via the first dispatch voice channel. Preferably, the private call request includes a call type indicator and a value of the call type indicator indicates image transfer over dispatch voice channel mode.

Also disclosed are systems and methods for transferring voice and non-voice data from a wireless device. According to one embodiment, a connection is established with a second wireless device over a dispatch voice channel, and non-voice data is transmitted to the second wireless device via the dispatch voice channel. Voice data for transmission to the second wireless device is received while the non-voice data is being transmitted to the second wireless device, and the transmission of the non-voice data is temporarily interrupted so as to transmit the voice data to the second wireless device via the dispatch voice channel. In a preferred embodiment, the transmission of the non-voice data is halted at a specified point; the voice data is transmitted to the second wireless device via the dispatch voice channel, and information indicating the specified point is used to resume transmission of the non-voice data to the second wireless device from the specified point.

### BRIEF DESCRIPTION OF THE DRAWINGS

FIG. 1 is a block diagram illustrating a conventional wireless communication system.

FIG. 2 is a more detailed block diagram of the wireless communication system of FIG. 1.

FIG. 3 is a block diagram illustrating a conventional wireless device.

FIGS. 4 and 5 are illustrations of a display on a wireless device according to one embodiment of the present invention.

FIG. 6 is an operational flow diagram showing a private push-to-view call setup process of a wireless device according to one embodiment of the present invention.

FIG. 7 is a diagram illustrating an information element used for identifying a call type according to one embodiment of the present invention.

FIG. 8 is an operational flow diagram showing an interruption of the push-to-view process of a wireless device according to one embodiment of the present invention.

FIG. 9 is an operational flow diagram showing a private call reconnect process of a push-to-talk wireless device according to one embodiment of the present invention.

FIG. 10 is a block diagram illustrating an interface between a speech encoder and a forward error corrector for a voice dispatch call according to one embodiment of the present invention.

FIG. 11 is a block diagram illustrating a forward error correction encoder for a voice dispatch call according to one embodiment of the present invention.

FIG. 12 is a block diagram illustrating an interface between input data and forward error correction for a non-voice data transfer call according to one embodiment of the present invention.

FIG. 13 is a block diagram illustrating a forward error correction encoder for a non-voice data transfer according to one embodiment of the present invention.

### DETAILED DESCRIPTION

The present invention, according to a preferred embodiment, overcomes problems with the prior art by allowing seamless data transfer capability over a dispatch voice channel.

More specifically, preferred embodiments of the present invention allow for the seamless transmission of voice and non-voice (i.e., image data) over one channel—the dispatch voice channel. This eliminates the need to switch back and forth between a dispatch voice channel and a data channel. In addition, this eliminates the necessity to acquire the IP address of the receiver before transmitting data over a data channel and the overhead associated with transferring data over a data channel, such as control processes. Thus, the present invention results in a reduction of the time necessary for completing a data transfer process. Additionally, the benefits of using a dispatch voice channel for voice transfer also applies to the user of the dispatch voice channel for image data transfer. This includes immediate communication, push-to-talk type processing and no number dialing requirement.

In addition, preferred embodiments of the present invention allow for the interruption of non-voice data transfer over a dispatch voice channel to allow for voice communication. The transfer of data is temporarily interrupted to allow the users of the devices to talk with each other. When the voice communication is completed, the data transfer process picks up where it left off and resumes transferring data without having to retransmit the data that it has already transmitted. This allows for easier and smoother communication as users are not required to wait for data transfer to be completed before attempting to communicate over the dispatch voice channel.

Also, preferred embodiments of the present invention allow for the use of current private call request and private call reconnection routines, with minimal modification. This is beneficial as it utilizes technology that is already in place and thus increases usability and compatibility.

Furthermore, preferred embodiments of the present invention use an enhanced forward error correction (FEC) coding algorithm with the data transfer process over the dispatch voice channel. The enhanced FEC protects all bits, which reduces the bit error rate during transmission. The enhanced FEC is preferably only utilized during the data transfer process, while the standard FEC coding algorithm is utilized during voice transmission. This allows for effective use of the same dispatch voice channel for both voice and non-voice data.

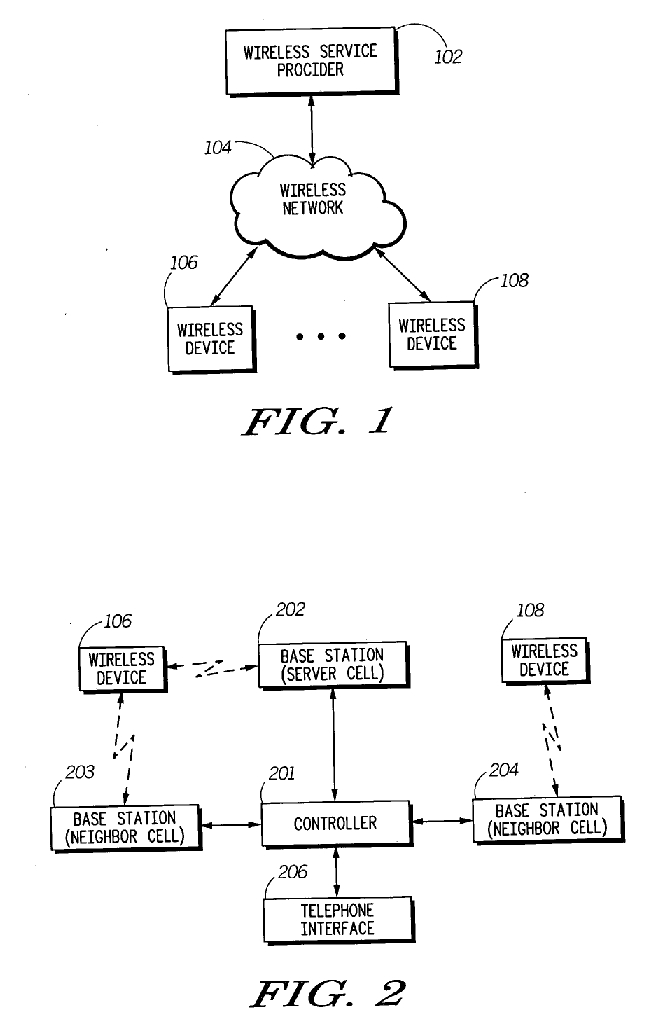

FIG. 1 is a block diagram illustrating a conventional wireless communication system. The exemplary wireless communication system of FIG. 1 includes a wireless service provider 102, a wireless network 104 and wireless devices 106 through 108. The wireless service provider 102 is a first-generation analog mobile phone service (1G), a second-generation (2G) digital mobile phone service (including interim 2.5G and 2.75G networks) or a third-generation (3G) Internet-capable mobile phone service. The exemplary wireless network 104 is a mobile phone network, a mobile text messaging device network, a pager network, or the like. Further, the communications standard of the wireless network 104 of FIG. 1 is Code Division Multiple Access (CDMA), Time Division Multiple Access (TDMA), Global System for Mobile Communications (GSM), General Packet Radio Service (GPRS), Frequency Division Multiple Access (FDMA) or the like.

The wireless network 104 supports any number of wireless devices 106 through 108, which are mobile phones, push-to-talk mobile radios, text messaging devices, handheld computers, pagers, beepers, or the like.

FIG. 2 is a more detailed block diagram of the wireless communication system of FIG. 1. The wireless communication system of FIG. 2 includes a controller 201 coupled to base stations 202, 203, and 204. In addition, the wireless communication system of FIG. 2 is interfaced to an external network through a telephone interface 206. The base stations 202, 203, and 204 individually support portions of a geographic coverage area containing subscriber units or transceivers (i.e., mobile devices) 106 and 108 (see FIG. 1). The mobile devices 106 and 108 interface with the base stations 202, 203, and 204 using a communication protocol, such as CDMA, TDMA, FDMA, GPRS or GSM.

The geographic coverage area of the wireless communication system of FIG. 2 is divided into regions or cells, which are individually serviced by the base stations 202, 203, and 204 (also referred to herein as cell servers). A mobile device operating within the wireless communication system selects a particular cell server as its primary interface for receive and transmit operations within the system. For example, mobile device 106 has cell server 202 as its primary cell server, and mobile device 108 has cell server 204 as its primary cell server. Preferably, a mobile device selects a cell server that provides the best communication interface into the wireless communication system. Ordinarily, this will depend on the signal quality of communication signals between a mobile device and a particular cell server.

As a mobile device moves between various geographic locations in the coverage area, a hand-off or hand-over may be necessary to another cell server, which will then function as the primary cell server (for example, a hand-off between cell servers 202 and 203). A mobile device monitors communication signals from base stations servicing neighboring cells to determine the most appropriate new server for hand-off purposes. Besides monitoring the quality of a transmitted signal from a neighboring cell server, the mobile device also monitors the transmitted color code information associated with the transmitted signal to quickly identify which neighbor cell server is the source of the transmitted signal.

FIG. 3 is a block diagram illustrating a conventional wireless device. FIG. 3 shows a wireless device 302, such as wireless devices 106 through 108 of FIG. 1. In one embodiment of the present invention, the wireless device 302 is a two-way radio capable of receiving and transmitting radio frequency signals over a communication channel under a communications protocol such as CDMA, FDMA, TDMA, GPRS or GSM. The wireless device 302 is capable of communicating over a fixed, two-way communications channel or operating over a dispatch voice channel, such as in a push-to-talk wireless device. Additionally, the wireless device 302 is capable of exchanging both voice data, such as speech data, and non-voice data, such as image data. For example, one embodiment includes a color display and camera sensors.

The wireless device 302 operates under the control of a controller 303, which switches the wireless device 302 between receive and transmit modes. In receive mode, the controller 303 couples an antenna 316 through a transmit/receive switch 314 to a receiver 304. The receiver 304 decodes the received signals and provides those decoded signals to the controller 303. In transmit mode, the controller 303 couples the antenna 316, through the switch 314, to a transmitter 312.

The controller 303 operates the transmitter and receiver according to instructions stored in memory 310. These instructions include a neighbor cell measurement scheduling algorithm 319. In preferred embodiments of the present invention, memory 310 is non-volatile memory, Flash memory or Random Access Memory. A timer module 311 provides timing information to the controller 303 to keep track of timed events. Further, the controller 303 can utilize the time information from the timer module 311 to keep track of scheduling for neighbor cell server transmissions and transmitted color code information.

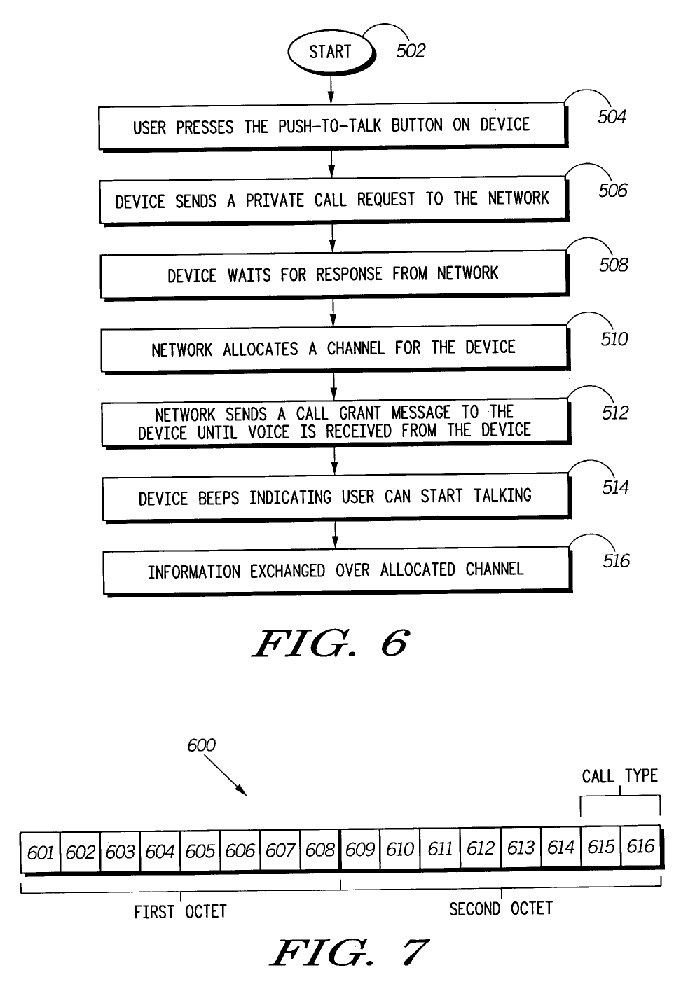

Processor 320 in FIG. 3 performs various functions such as the functions attributed to the call setup procedures and encoding procedures described below with reference to FIGS. 6, 11 and 12. In various embodiments of the present invention, the processor 320 in FIG. 3 is a single processor or more than one processor for performing the tasks described below.

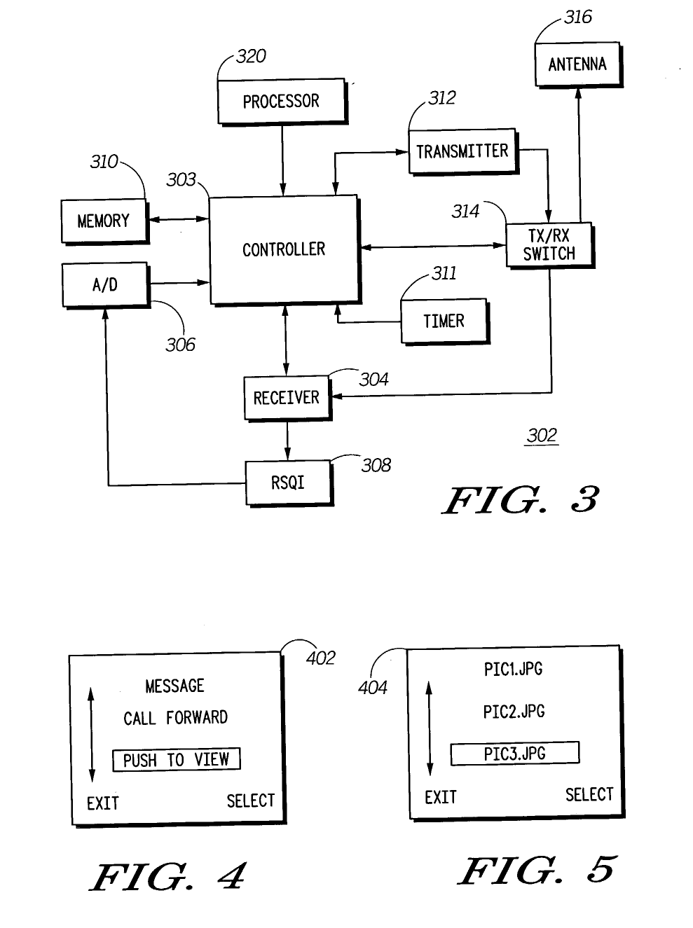

FIGS. 4 and 5 are illustrations of a display on a wireless device for transmitting an image over a dispatch voice channel, according to one embodiment of the present invention. FIG. 4 shows an initial display 402 on a push-to-talk wireless device 302 having the capability of transmitting an image over a dispatch voice channel, as described in the present invention. The initial display 402 is presented to the user upon power up of the wireless device 302 or upon selection of the screen from a previous list presented to the user. FIG. 4 shows a list of user selections: Message, Call Forward and Push to View. Each selection is associated with a function of the wireless device 302. The Push to View selection is associated with the transfer of an image over a dispatch voice channel. Also presented in the display 402 is a scroll bar on the left hand side for scrolling through user selections, an Exit button for exiting the current screen and a Select button for indicating the selection of one of the user selections.

FIG. 5 shows a second display 404 on a push-to-talk wireless device having the capability of transmitting an image over a dispatch voice channel, as described in the present invention. The second display 404 is presented to the user after the Push to View selection is selected by the user from the first display 402. FIG. 5 shows a list of images stored on the phone that the user may transmit via the image transfer function of the present invention: Pic1.jpg, Pic2.jpg and Pic4.jpg in this example. Also presented in the second display 404 is a scroll bar on the left hand side for scrolling through user selections, an Exit button for exiting the current screen and a Select button for indicating the selection of one of the user selections.

Once an image is selected by the user by navigating or scrolling through the list of images, the transfer of the image is initiated by pressing the Push-to-Talk button of the wireless device 302, or by pressing another button or combination of buttons in further embodiments.

FIG. 6 is an operational flow diagram showing a private call setup process of a push-to-talk wireless device according to one embodiment of the present invention. More specifically, the operational flow diagram of FIG. 6 shows a private call setup process of a push-to-talk wireless device on a wireless network for transmitting an image over a dispatch voice channel, in one embodiment of the present invention. That is, FIG. 6 depicts the process of setting up a call for a push-to-talk wireless device 302 on a wireless network 104 for the purpose of transmitting an image over a dispatch voice channel. The operational flow diagram of FIG. 6 begins with step 502 and flows directly to step 504.

In step 504, the user of the wireless device 302 presses the push-to-talk button. This indicates to the wireless device 302 that the user is ready to begin transmitting information—either audio or non-audio (i.e., image data). Then, the wireless device 302, in step 506, transmits a private call request to the wireless network 104. Embedded in the private call request of step 506 is an “Information Element,” in which is further embedded a call type indicator. The call type indicator of the Information Element describes whether the private call request is associated with conventional audio exchange or non-audio transmission (e.g., image transfer). The Information Element is described in greater detail below with reference to FIG. 7.

Subsequent to step 506, the wireless network 104 proceeds to attempt to set up a call between the wireless device 302 and the intended recipient of the call. In the interim, the user and the wireless device 302, in step 508, wait for a call grant message from the wireless network 104.

The wireless network 104, in step 510, proceeds to complete a connection with the intended recipient of the call and subsequently allocates a channel for communication for the wireless device 302. Next, the wireless network 104, in step 512, transmits a call grant message to the wireless device 302. The call grant message is a message indicating to the wireless device 302 that a connection with the intended recipient of the call has been made and that a channel for communication has been allocated—a traffic channel. The wireless network 104 continues to transmit a call grant message to the wireless device 302 until transmitted audio is received from the wireless device 302.

In the event that the wireless network 104 does not allocate a channel for the wireless device 302 because the call setup procedure was not successful (for example, due to the unavailability of channels or the unavailability of the receiving wireless device), then in an alternative step the wireless network 104 notifies the wireless device 302 that the call setup has failed. In one embodiment, voice announcements are provided to the wireless device 302 indicating the status of the call setup procedure. In some embodiments, the wireless device 302 must make three attempts at executing the call setup procedure before the wireless device 302 notifies the user that the call setup has failed.

When the call grant message is received from the wireless network 104, the wireless device 302, in step 514, indicates to the user that the wireless device is ready to begin receiving audio for transmission. In one embodiment, the wireless device 302 indicates this by generating a beep or other representative tone. It should be noted that there is typically a delay between step 504 and step 514. That is, there is a delay between the time the user presses the push-to-talk button and the time the wireless device 302 beeps to indicate that it is ready to begin transmitting audio.

Subsequently, in step 516, the user begins transmitting either audio (by speaking into the wireless device 302, for example) or non-audio data (such as an image, for example) via the wireless device 302 over the traffic channel allocated by the wireless network 104. In step 516, information is exchanged over the allocated traffic channel between the two wireless devices, such as wireless devices 106 and 108.

The allocation of the traffic channel continues as long as information is being exchanged between the two wireless devices. Typically, a hang timer is initiated when the traffic channel is allocated. The hang timer measures the amount of time that has passed since the last communication over the traffic channel. When the amount of time since the last communication over the traffic channel has passed beyond a threshold (6-10 seconds, for example), the allocated traffic channel is dropped. Once a traffic channel has been dropped, in order to re-establish communication, the wireless devices must reconnect using a private call reconnection routine, such as the one described below with reference to FIG. 9. Alternatively, the wireless devices may reconnect by executing the private call setup procedure of FIG. 6.

It should be noted that the exemplary process of FIG. 6 is similar to the conventional private call setup process of a push-to-talk wireless device on a wireless network. However, the private call request message is modified to indicate image transfer mode to the recipient (for example, in the exemplary process of FIG. 6 the call type indicator is modified to indicate a data transfer call). Thus, image transfer over the dispatch voice channel is possible without new control messaging.

FIG. 7 is a diagram illustrating an Information Element 600 used for identifying a call type over a dispatch voice channel according to one embodiment of the present invention. As described above with reference to FIG. 6, the wireless device 302, in step 506, transmits a private call request to the wireless network 104. Embedded in the private call request of step 506 is an Information Element, in which is further embedded a call type indicator. The call type indicator of the Information Element describes whether the private call request is associated with conventional audio exchange or non-audio transmission (e.g., image transfer).

The Information Element 600 of this embodiment is a 16 bit value divided into two octets. The first octet is the first 8 bits of the Information Element 600 (i.e., bits 601, 602, 603, 604, 605, 606, 607 and 608). The second octet is the second 8 bits of the Information Element 600 (i.e., bits 609, 610, 611, 612, 613, 614, 615 and 616). The second octet, referred to as the Information Element Identifier, includes a call type indicator of two bits—bits 615 and 616. The call type indicator of the Information Element Identifier describes the type of the call that is being requested in the private call request sent by the wireless device 302.

Note that two bits, bits 615 and 616, can hold up to four values. In one exemplary embodiment, the two bits 615 and 616 indicate the following three types of calls. The first type of call is a 6:1 private voice call. This indicates a compression scheme of 6:1 in which a TDMA slot is 15 ms and thus 6 calls fit into one slot. The second type of call is a 12:1 private voice call. This indicates a compression scheme of 12:1 in which 12 calls fit into one TDMA slot. The third type of call indicates a data transfer call, as described with reference to the present invention. In further embodiments of the present invention, one or more other bits of the Information Element 600 (such as reserved bits) are used to indicate that the call is a data transfer call.

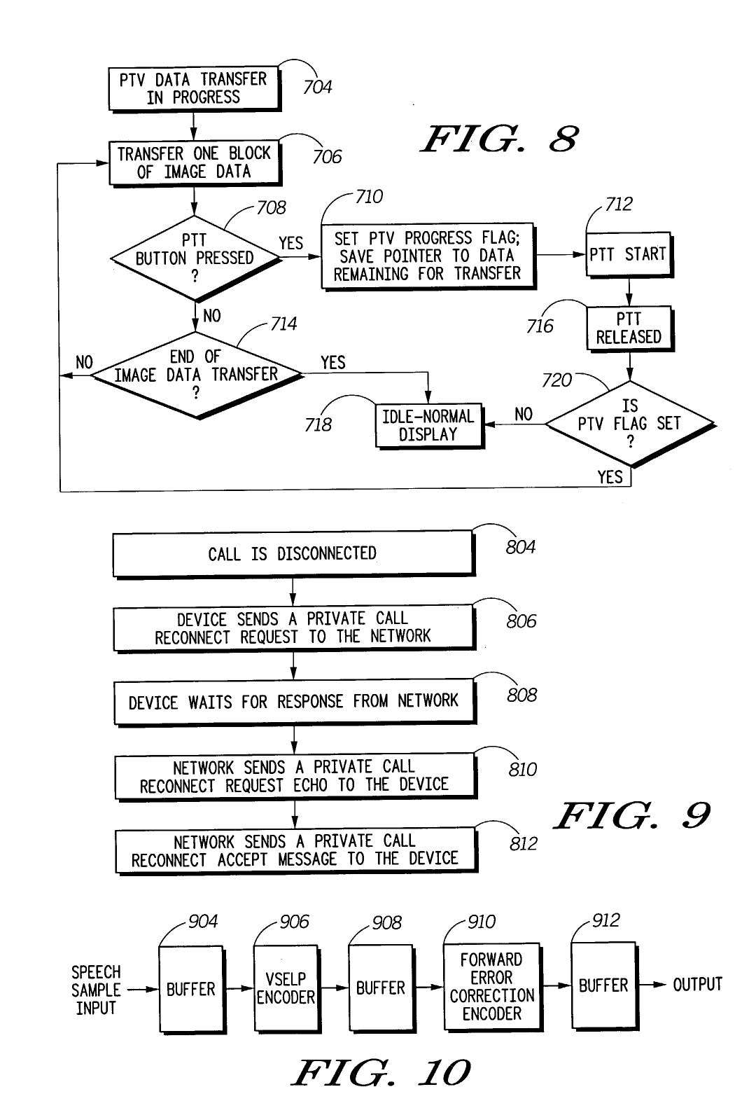

FIG. 8 is an operational flow diagram showing an interruption of the image transfer process over a dispatch voice channel of a wireless device according to one embodiment of the present invention. FIG. 8 shows the process when the image transfer process is interrupted to allow for voice communication. The operational flow diagram of FIG. 8 shows how the image transfer process saves the current state of the image transfer and continues unabated after the interruption has passed.

In step 704, the image transfer process (i.e., the Push to View data transfer process) has commenced and is in progress. In one embodiment, in step 704 the wireless device 302 and the receiving wireless device exchange unique identifiers that are associated with each wireless device (e.g., Dispatch IDs). The unique identifiers are used during information exchange in order to correctly identify the recipient of outgoing (voice or non-voice) data or messages. In step 706, one block of image data (such as a 215-bit frame of data) is transferred. In step 708, it is determined whether the Push to Talk button on the wireless device 302 has been pressed. If the Push to Talk button on the wireless device 302 has been pressed, then control flows to step 710. If the Push to Talk button on the wireless device 302 has not been pressed, then control flows to step 714.

In step 714, it is determined whether the image transfer process has finished. That is, it is determined whether the entire image has been transferred during the image transfer process. If the entire image has been transferred, then control flows to step 718. If the entire image has not been transferred, then control flows back to step 706 where the next block of the image is transferred.

In step 710, a flag is set to indicate that the image transfer process has been interrupted. Next, a pointer is stored indicating the last block of data of the image that has been transferred. This pointer indicates where the image transfer process left off during the process before it was interrupted. For example, the pointer can be a number indicating the sequential number of the last data block (frame) transmitted. Alternatively, image size, known to both sides, can be used as an indicator of the progress of the image transfer.

In step 712, the Push to Talk process commences to allow the user to transmit audio to the other wireless device. In step 716, the Push to Talk process ends. In step 720, it is determined whether the flag (as described in step 710) has been set. If the flag has been set, then control flows back to step 706 where the image transfer process resumes where it left off. In this case, the image transfer process reads the pointer information stored in step 710 and resumes transferring the image from the location where it was interrupted. If the flag has not been set, then control flows to step 718.

In step 718, the display of the wireless device (as shown in FIGS. 4 and 5) returns to a normal or idle display status. Thus, if a voice private call is attempted by the user of a wireless device that is transmitting non-voice data (e.g., image data), then the image transmission is interrupted (i.e., put on hold) to allow voice communication. Similarly, if a voice private call is attempted by the user of a wireless device that is receiving non-voice data (e.g., image data), the image transmission can be interrupted in an analogous manner. For example, the receiving wireless device can initiate a voice private call and later the transmitting wireless device can check whether or not non-data transfer was completed.

FIG. 9 is an operational flow diagram showing a private call reconnect process of a push-to-talk wireless device over a dispatch voice channel according to one embodiment of the present invention. The operational flow diagram of FIG. 9 shows a private call reconnect process of a push-to-talk wireless device on a wireless network for transmitting an image over a dispatch voice channel, in one embodiment of the present invention. That is, FIG. 9 depicts the process of reconnecting a call for a push-to-talk wireless device 302 on a wireless network 104 for the purpose of transmitting an image over a dispatch voice channel.

In step 804, a call is disconnected. This may be due to the expiration of the hang timer, dropping of the traffic channel due to high communication traffic, etc. In step 806, the wireless device 302 attempts to reconnect. This may be a result of the user of the wireless device 302 pressing the Push to Talk button, or a similar indicator. As a result, the wireless device 302 transmits a private call reconnect request to the wireless network 104. Next, in step 808, the wireless device 302 waits for a response from the wireless network 104.

The wireless network 104, in step 810, transmits a private call reconnect request echo to the wireless device 302. The private call reconnect request echo is a message indicating to the wireless device 302 that the wireless network 104 has received the private call reconnect request and is attempting to reconnect the two parties. Subsequent to step 806, the wireless network 104 proceeds to attempt to reconnect the wireless device 302 and the intended recipient of the call. In the interim, the user and the wireless device 302, in step 808, wait for a private call reconnect accept message from the wireless network 104.

The wireless network 104 proceeds to complete a reconnection with the intended recipient of the call and subsequently allocates a channel for communication for the wireless device 302. Next, the wireless network 104, in step 812, transmits a private call reconnect accept message to the wireless device 302. The private call reconnect accept message is a message indicating to the wireless device 302 that a reconnection with the intended recipient of the call has been made and that a channel for communication has been allocated—a traffic channel. The wireless network 104 continues to transmit a private call reconnect accept message to the wireless device 302 until transmitted data is received from the wireless device 302.

In the event that the wireless network 104 does not allocate a channel for wireless device 302 because the call reconnect procedure was not successful (for example, due to the unavailability of a channel or the unavailability of the receiving wireless device), then in an alternative step the wireless network 104 notifies the wireless device 302 that the call reconnect has failed. In one embodiment, voice announcements are provided to the wireless device 302 indicating the status of the call reconnect procedure.

In some embodiments, the wireless device 302 must make three attempts at executing the call reconnect procedure before the wireless device 302 notifies the user that the call reconnect routing has failed. If the call was dropped during an image transfer and the private call reconnect procedure is abandoned after three tries, then the pointer to the remaining image data on the sending wireless device is erased. Likewise, the partial image data received by the receiving wireless device is also erased.

In response to receiving the private call reconnect accept message from the wireless network 104, the wireless device 302 indicates to the user that the wireless device is ready to begin receiving audio for transmission. In one embodiment, the wireless device 302 indicates this by generating a beep or other representative tone, and then the user can begin transmitting further audio (by speaking into the wireless device 302, for example) via the wireless device 302 over the traffic channel allocated by the wireless network 104.

If the call was dropped during an image transfer, the pointer to the remaining image data on the sending wireless device is used to resume the image data transfer from where it left off when the call was dropped. When a call is dropped during an image transfer, this pointer is stored to indicate the last block of data that has been transferred (i.e., where the image transfer process left off before the call was dropped). For example, the pointer can be a number indicating the sequential number of the last data block (frame) transmitted. Alternatively, image size, known to both sides, can be used as an indicator of the progress of the image transfer. Thus, after the call is reconnected the image transfer process resumes where it left off.

It should be noted that the exemplary process of FIG. 9 is similar to the conventional private call reconnect process of a push-to-talk wireless device on a wireless network. However, the conventional private call reconnect process is modified in the exemplary process of FIG. 9 so as to enable the reconnect process to operate when transferring an image over the dispatch voice channel.

FIG. 10 is a block diagram illustrating an interface between a speech encoder and a forward error corrector for a voice dispatch call according to one embodiment of the present invention. In a mobile fading channel environment, forward error correction (FEC) algorithms are used to protect speech bits from the errors introduced by the channel. Due to inherent properties of speech, it is possible to recover reasonably good speech quality at a receiver, even if a number of the speech bits have been corrupted by the channel. A bit error rate (BER) is defined as the percentage of bits received in error at a receiver. Typically, speech communication is possible at a higher BER compared to data communication. That is, image data has less tolerance for errors and requires extremely low BER to maintain a minimum quality of service (QoS). As a result, image transfer (data communication) requires more protection against channel errors compared to speech communication in voice dispatch mode.

It should be noted that the terms “voice dispatch mode” and “dispatch voice channel mode” refer to a method of radio communication that is typically used for push-to-talk (PTT) two-way radio communication. Typically, voice dispatch mode uses a communication protocol, such as CDMA, TDMA, FDMA, GPRS or GSM, in a half-duplex fashion, such that only one party can transfer (voice or non-voice) data at a time. The term “dispatch voice channel” refers to the communications channel used for a voice dispatch call in voice dispatch mode.

FIG. 10 illustrates an interface between a Vector Sum Excited Linear Prediction (VSELP) encoder 906 (a speech coder used for compression of speech 902) and an FEC block 910 for a voice dispatch call. A high-level block diagram of such a FEC block is described in greater detail below with reference to FIG. 11.

In FIG. 10, a set of speech samples are stored in a buffer 904 and read by the VSELP encoder 906. In one embodiment, the buffer 904 holds 240 samples of voice data, with each frame having 30 ms and 126 samples. The VSELP encoder 904 compresses each 30 ms of a speech frame to 126 bits. Compression of three encoded speech frames (equivalent to 3×30=90 ms) results in 378 (3×126) bits of encoder output. These 378 bits are stored in a second buffer 908 and used as input to the FEC 910.

In the FEC 910, 90 speech bits are not protected and the FEC adds redundancy in the remaining compressed speech bits using a multi-rate trellis coder. The FEC outputs 332 real symbols (RS) to a third buffer 912. Subsequently, the data in the third buffer 912 is passed to a modem for transmission via output 914. Note that the receiver (not shown) performs the inverse operation and 378 compressed encoder bits are recovered from 332 received real symbols (RS) using an FEC decoder.

FIG. 11 is a block diagram illustrating a forward error correction encoder for a voice dispatch call according to one embodiment of the present invention. FIG. 11 illustrates the FEC algorithm 910 in more detail. FIG. 11 shows a bit priority module 1002 for prioritizing the 378 input bits 1001 read from second buffer 908. The bit priority module 1002 receives a portion of input data (such as 30 ms of speech) in the form of compressed vocoder bits and rearranges them according to their importance, on a frame-by-frame basis. The size of the input data is the same as the size of the output data for the bit priority module 1002, but three output frames are individually re-sequenced based on their sensitivity. This prepares the bits (using all bits from three frames at the same time) for the bit reordering module 1006, which classifies them into different groups. As such, the bit priority module facilitates higher FEC protection to the most sensitive bits by the subsequent FEC modules.

Preferably, a 6-bit cycling redundancy check (CRC) calculation module calculates a flag or code based on the output of the bit priority module 1002. This code is then transmitted to the receiving side along with the corresponding data bits in order to verify the data bits (i.e., for frame error detection). Next, the bit reordering module 1006 processes the bits output from the priority module 1002 (preferably after they are processed by a CRC calculation module). The bit reordering module 1006 reorders the bits output from the priority module 1002 according to sensitivity. Subsequently, the bits are input into a multi-rate trellis coder 1008. The trellis coder 1008 adds redundancy to the bits output from the bit reordering module 1006 for error correction purposes. The receiving side is aware of the redundancy performed by the trellis coder 1008 and decodes the received data accordingly.

The trellis coder 1008 outputs 664 coded bits, which are subsequently input into the interleaving module 1010, which maps the 664 coded bits to 332 real symbols (RS) at the output 1011. The interleaving module 1010 shuffles the bits output from the trellis coder 1008 in order to guard against bursting errors that are not adequately handled by the data redundancy added by the trellis coder 1008. The output 1011 is supplied to the third buffer 912.

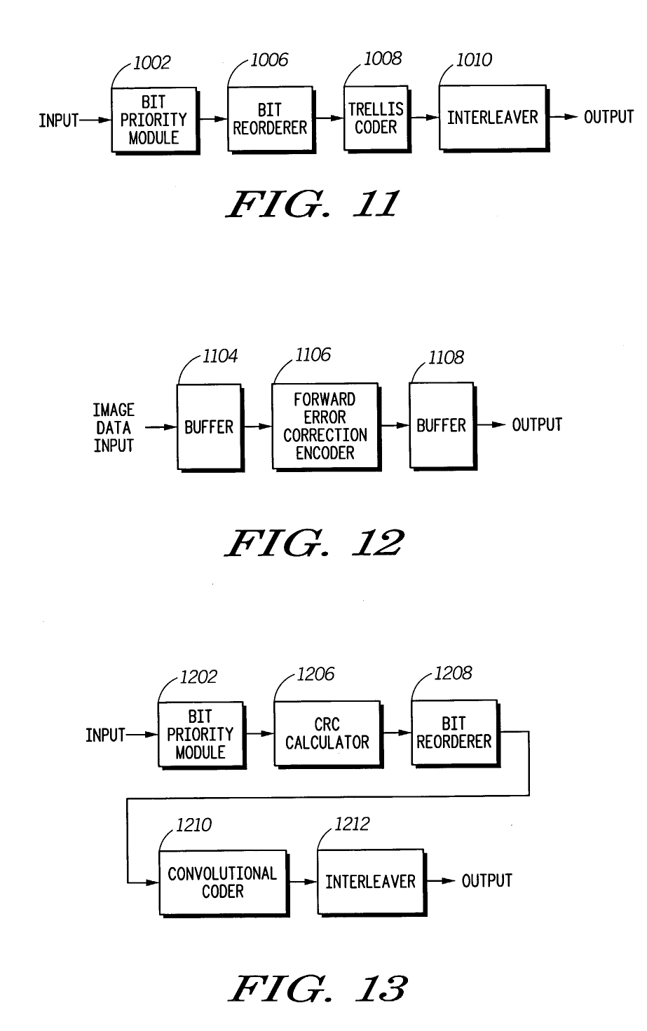

In the image transfer mode of the preferred embodiment of the present invention, a VSELP speech encoder is not used and an enhanced (more powerful) FEC coding algorithm is used to ensure image data is protected from channel errors. FIG. 12 is a block diagram illustrating an interface between input data (i.e., image data) and a FEC algorithm 1106 for a non-voice data transfer according to one embodiment of the present invention.

The block diagram of FIG. 12 shows stored image data 1102 input to the buffer 1104. In one embodiment, the buffer 1104 holds 215 bits of image data 1102. These 215 bits are used as input to the FEC 1106. The FEC algorithm 1106 outputs 332 real symbols (RS) to the buffer 1108. Subsequently, the data in the second buffer 1108 is passed to a modem for transmission.

FIG. 13 is a block diagram illustrating a forward error correction encoder for a non-voice data transfer over a dispatch voice channel according to one embodiment of the present invention. FIG. 13 illustrates the FEC encoder 1106 of FIG. 12 in more detail.

FIG. 13 shows a bit priority module 1202 for prioritizing the 215 input bits 1201 read from the second buffer 1108. The bit priority module 1202 receives a portion of input data (such as 30 ms of speech) in the form of compressed vocoder bits and rearranges them according to their importance, on a frame-by-frame basis. The size of the input data is the same as the size of the output data for the bit priority module 1202, but three output frames are individually re-sequenced based on their sensitivity. This prepares the bits (using all bits from three frames at the same time) for the bit reordering module 1208, which classifies them into different groups. As such, the bit priority module facilitates higher FEC protection to the most sensitive bits by the subsequent FEC modules.

Then, the 6-bit cycling redundancy check (CRC) calculation module 1206 processes the 215 input bits and outputs 221 bits. The CRC module 1206, calculates a flag or code based on the input bits. This code is then transmitted to the receiving side along with the corresponding data bits in order to verify the data bits. Next, the bit reordering module 1208 processes the 221 bits. The bit reordering module 1208 reorders the bits output from the CRC module 1206 according to sensitivity. Subsequently, the bits output from the bit reordering module 1208 are input into a convolutional coding module 1210, which outputs 663 coded bits.

The convolutional coding module 1210 operates at a ⅓ rate with 64 states, and adds six flush bits (all zeroes) to its output. The convolutional coding module 1210 adds redundancy to the bits output from the bit reordering module 1208 for error correction purposes. The receiving side is aware of the redundancy performed by the convolutional coding module 1210 and decodes the received data accordingly.

Subsequently, the interleaving module 1212 maps the 663 coded bits to 332 real symbols (i.e., output data 1214). The interleaving module 1212 shuffles the bits output from the convolutional coding module 1210 in order to guard against bursting errors that are not adequately handled by the data redundancy added by the convolutional coding module 1210.

In this embodiment the enhanced FEC encoder 1106 for image transfer mode utilizes a ⅓-rate convolutional coder 1210 with 64 states and all image bits are coded. Each 90 ms slot contains 215 image bits providing an effective data rate of 2388 bps. Thus, about 23 sec are necessary to transfer a 6.6 Kb JPEG image (typical 120×160 pixel JPEG encoded image). On the transmit side, 215 bits (per 90 ms) are used as input to an FEC decoder, which results in 332 RS—same number of RS as for voice call. The first frame also contains the image size information and hence both sending and receiving devices know the amount of data that needs to be transferred.

The FEC encoder 1106 for data transfer has superior BER performance (error free for most practical purposes) due to the following two factors: 1) higher coding gain due to a more powerful FEC coding algorithm (larger constraint length of convolutional coder results in larger free distance) and 2) unlike the FEC coding for voice mode, all bits are coded/protected with a rate-⅓ coder. This high performance, however, is achieved at a cost of a reduction in data rate (i.e., the number of bits transmitted per second). Note that for voice dispatch mode, typically 378 bits are transferred in 90 ms as compared to only 215 bits in 90 ms for image transfer mode.

A typical mobile handset uses two digital PU (processing units) or processors: a DSP processor (for real-time processing of speech, modem etc.) and a host processor (e.g., microprocessor). Preferably, the DSP processor and the host processor are on the same integrated circuit chip. Typically, the images are stored in flash memory at the host processor. Preferably on the transmit side, image data is transferred to the DSP processor via host-DSP messaging. Host-DSP messaging refers to the transfer of data (or messages) between the host processor and the DSP processor through a shared memory, and can be performed with single word or multiple word messages.

On the receive side, image data is moved to the host processor for storage via the same DSP-host long messaging. The host processor also keeps track of image size. On the transmit side it prompts the DSP processor when the whole image has been transferred to the receiver. Similarly, on the receive side, the host knows when the image transfer is completed.

A number of voice-centric algorithms are not useful for image transfer mode and are preferably not used. For example, a conventional DTX (discontinuous transmission) algorithm turns off the transmitter during silence frames in communications, which results in longer battery life (power saving). DTX, however, is preferably not used during image transfer mode. Similarly, conventional error mitigation algorithms that are intended for voice calls are preferably disabled during the image transfer mode.

The present invention can be realized in hardware, software, or a combination of hardware and software in a wireless device (such as wireless devices 106 and 108). A system according to a preferred embodiment of the present invention can be realized in a centralized fashion in one computer system (of the wireless device), or in a distributed fashion where different elements are spread across several interconnected computer systems. Any kind of computer system—or other apparatus adapted for carrying out the methods described herein—is suited. A typical combination of hardware and software could be a general purpose processor with a computer program that, when being loaded and executed, controls the processor such that it carries out the methods described herein.

The present invention can also be embedded in a computer program product (e.g., in the wireless device), which comprises all the features enabling the implementation of the methods described herein, and which—when loaded in a system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer (or machine) readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for transmitting non-voice data over a dispatch voice channel of a wireless network, said method comprising the steps of:
receiving a request from a user of a first wireless device to transfer non-voice data;
transmitting a private call request to the wireless network, the private call request including information indicating image transfer over dispatch voice channel mode;
receiving a call grant message from the wireless network, the call grant message indicating a first dispatch voice channel that has been allocated to the first wireless device; and
transmitting the non-voice data from the first wireless device to the second wireless device via the first dispatch voice channel.

2. The method of claim 1, wherein the step of receiving a request from a user includes the sub-steps of:
receiving a request to transfer an image over a dispatch voice channel; and
receiving a selection of an image to transmit to the second wireless device,
wherein the non-voice data is image data for the selected image.

3. The method of claim 1, further comprising the steps of:
transmitting a private call reconnect request to the wireless network;
receiving a private call reconnect accept message from the wireless network;
the private call reconnect accept message indicating a second dispatch voice channel that has been allocated to the first wireless device; and
resuming transmission of the non-voice data via the second dispatch voice channel from a point at which transmission was interrupted.

4. The method of claim 1, wherein the private call request includes a call type indicator and a value of the call type indicator indicates image transfer over dispatch voice channel mode.

5. The method of claim 1, further comprising the step of:
transmitting voice data from the first wireless device to the second wireless device via the first dispatch voice channel, the voice data being processed using a first forward error correction algorithm before transmission,
wherein in the step of transmitting the non-voice data, the non-voice data is processed using a second forward error correction algorithm before transmission.

6. A wireless device having a voice dispatch mode, said wireless device comprising:
an input interface for receiving a request from a user of the wireless device to transfer non-voice data;
a transmitter for transmitting a private call request to the wireless network, the private call request including information indicating image transfer over dispatch voice channel mode; and
a receiver for receiving a call grant message from the wireless network, the call grant message indicating a first dispatch voice channel that has been allocated to the wireless device,
wherein after the call grant message is received, the transmitter transmits the non-voice data from the wireless device to another wireless device via the first dispatch voice channel.

7. The wireless device of claim 6, wherein the input interface receives a request to transfer an image over a dispatch voice channel and a selection of an image to transmit, the non-voice data bring image data for the selected image.

8. The wireless device of claim 6,
wherein the transmitter transmits a private call reconnect request to the wireless network,
the receiver receives a private call reconnect accept message from the wireless network; the private call reconnect accept message indicating a second dispatch voice channel that has been allocated to the wireless device, and
after the private call reconnect accept message is received, the transmitter resumes transmission of the non-voice data via the second dispatch voice channel from a point at which transmission was interrupted.

9. The wireless device of claim 6, wherein the private call request includes a call type indicator and a value of the call type indicator indicates image transfer over dispatch voice channel mode.

10. The wireless device of claim 6, further comprising:
a first forward error correction means for processing voice data before transmission; and
a second forward error correction means for processing non-voice data before transmission.

11. A method for transferring voice and non-voice data from a wireless device, said method comprising the steps of:
establishing a connection with a second wireless device over a dispatch voice channel;
transmitting non-voice data to the second wireless device via the dispatch voice channel;
receiving voice data for transmission to the second wireless device while the non-voice data is being transmitted to the second wireless device; and
temporarily interrupting the transmission of the non-voice data so as to transmit the voice data to the second wireless device via the dispatch voice channel.

12. The method of claim 11, wherein the non-voice data is image data.

13. The method of claim 11, wherein the step of temporarily interrupting the transmission of the non-voice data includes the sub-steps of:
halting the transmission of the non-voice data at a specified point in the non-voice data and storing information indicating the specified point;
transmitting the voice data that was received to the second wireless device via the dispatch voice channel; and
using the information indicating the specified point to resume transmission of the non-voice data to the second wireless device from the specified point at which transmission was halted.

14. The method of claim 11, wherein the step of receiving voice data includes the sub-steps of:
receiving a request from a user of the wireless device to transmit speech to the second wireless device;
receiving speech from the user of the wireless device; and
deriving voice data from the speech from the user.

15. The method of claim 11,
wherein in the temporarily interrupting step, the voice data is processed using a first forward error correction algorithm before transmission, and
in the transmitting step, the non-voice data is processed using a second forward error correction algorithm before transmission.

16. A wireless device having a voice dispatch mode, said wireless device comprising:
a telephony processor for establishing a voice dispatch connection with a second wireless device over a dispatch voice channel;
a transmitter for transmitting voice and non-voice data to the second wireless device via the dispatch voice channel; and
a voice input circuit for receiving speech and outputting voice data for transmission to the second wireless device,
wherein if speech or a request to transmit speech is received during transmission of non-voice data to the second wireless device via the dispatch voice channel, the transmitter temporarily interrupts the transmission of the non-voice data and transmits the voice data output from the voice input circuit to the second wireless device via the dispatch voice channel.

17. The wireless device of claim 16, wherein the non-voice data is image data.

18. The wireless device of claim 16, wherein the transmitter temporarily interrupts the transmission of the non-voice data and transmits the voice data by halting the transmission of the non-voice data at a specified point in the non-voice data, storing information indicating the specified point, transmitting the voice data output from the voice input circuit via the dispatch voice channel, and then using the information indicating the specified point to resume transmission of the non-voice data to the second wireless device from the specified point at which transmission was halted.

19. The wireless device of claim 16, wherein the transmitter includes:
a first forward error correction means for processing voice data before transmission; and
a second forward error correction means for processing non-voice data before transmission.

20. The wireless device of claim 16, wherein a unique identifier is associated with the wireless device, the unique identifier being used in transmitting voice and non-voice data to the second wireless device.
